(19) United States
(12) Patent Application Publication
(10) Pub. No.: US 2016/0375303 A1
(43) Pub. Date: Dec. 29, 2016

(54) INFORMATION GATHERING DEVICE AND METHOD USING THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: Xi-Huai HE, Wuhan (CN); Chun-Sheng CHEN, New Taipei (TW)

(21) Appl. No.: 14/795,340

(22) Filed: Jul. 9, 2015

(30) Foreign Application Priority Data
Jun. 26, 2015 (CN) 201510360549.6

(51) Int. Cl. A63B 24/00; B60K 35/00; A63B 22/06

(52) U.S. Cl. CPC A63B 24/0062; A63B 22/0605; B60K 35/00; A63B 2220/30; A63B 2220/40

(57) ABSTRACT

An information gathering device includes a gathering unit, a data processing unit coupled to the gathering unit, and a display unit coupled to the data processing unit. The gathering unit is located on a moving or stationary exercise device to gather data signals from the riding device to send them to the data processing unit. The data processing unit converts the data signal into displayable and send the displayable data to the display unit, and the display unit displays the displayable data received from the data processing unit. The disclosure further provides an information gathering method.

### FIELD

The subject matter herein generally relates to data acquisition.

### BACKGROUND

Electric bicycles or other electric assisted vehicles allow a rider to ride where they would not normally be able to go. Stationary exercise bikes allow for riders to adjust the workout based on heart rate. Riding data, including a heart rate, a trip distance and a trip time, can be used by many exercise programs and coaches as an accurate guideline to the work intensity performed by the person exercising. A person may adjust their exercise level to be able to raise or lower their heart rate, their trip distance and their trip time.

### BRIEF DESCRIPTION OF THE DRAWINGS

Implementations of the present technology will now be described, by way of example only, with reference to the attached figures.

FIG. 1 is a block diagram of one embodiment of a information gathering device.

FIG. 2 is a block diagram of one embodiment of function modules of the information gathering device of FIG. 1.

FIG. 3 is a flowchart of one embodiment of a information gathering method using the information gathering device of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an information gathering device. The information gathering device includes a gathering unit, a data processing unit coupled to the gathering unit, and a display unit coupled to the data processing unit. The gathering unit is located on a stationary or mobile device to gather data generated by the riding device to send to the data processing unit. The data processing unit is used to convert the data signal into displayable and send the displayable data to the display unit, and the display unit displays the displayable data. The disclosure further provides an information gathering method.

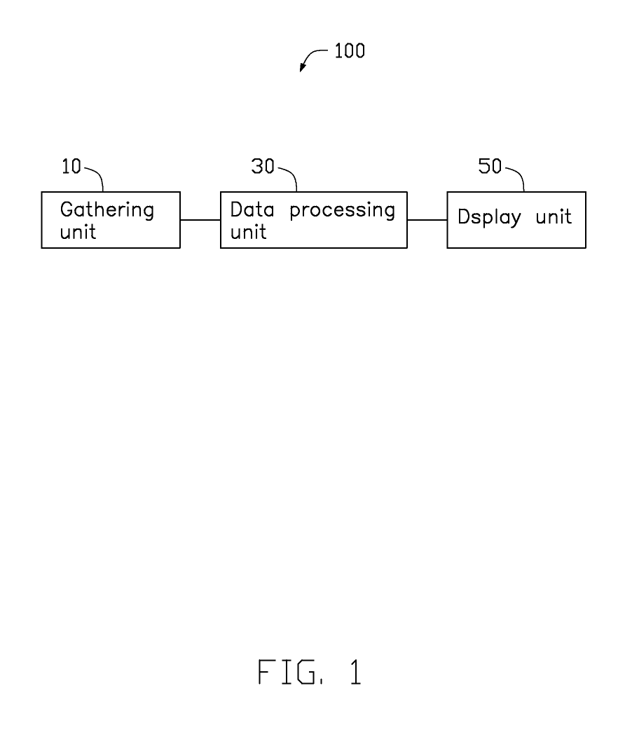

FIG. 1 illustrates an embodiment of an information gathering device 100. The information gathering device 100 includes a gathering unit 10, a data processing unit 30 coupled to the gathering unit 10, and a display unit 50 coupled to the data processing unit 30. In at least one embodiment, the data processing unit 30 can be coupled to the gathering unit 10 by wireless, such as blue-tooth or infrared, or by Universal Serial Bus (USB), and the data processing unit 30 also can be coupled to the display unit 30 by wireless, such as by BLUETOOTH, or by infrared, or by USB.

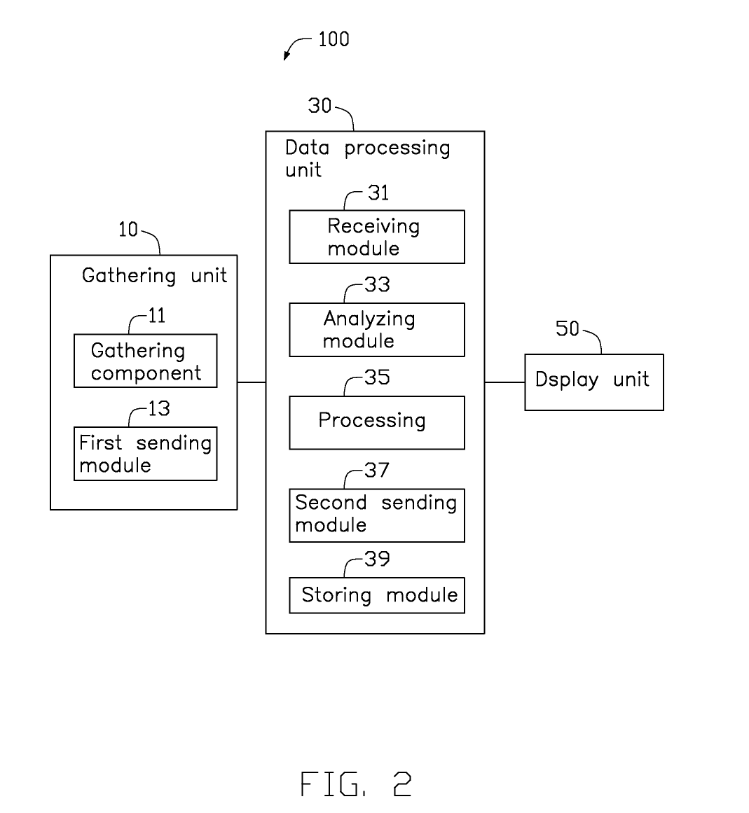

FIG. 2 illustrates a detail view of the information gathering device 100. The gathering unit 10 can include a gathering component 11 and a first sending module 13 coupled to the gathering component 11. The gathering component 11 is configured to gather a data of a riding device (not shown). In at least one embodiment, the riding device can be a human-powered vehicle such as a bicycle or a stationary fitness device, and the gathering component 11 can be a G-sensor, an accelerometer, or a gyroscope. The gathering component 11 can be located on a footboard of the riding device to obtain the data of the riding device. The data of the riding device can include a constant speed, a speed of acceleration, a suddenness of stopping, a riding in reverse, and so on. The first sending module 13 is configured to send a signal of the data to the data processing unit 30.

The data processing unit 30 is configured to convert the data signal into displayable and send the displayable data to the display unit 50, so the displayable data can be sent to the display module 50. The data processing unit 30 can include a receiving module 31, an analyzing module 33, a processing module 35, and a second sending module 37. The receiving module 31 is configured to receive the data signals from the first sending module 13 and send the same to the analyzing module 33. The analyzing module 33 is configured to analyze the data signal to the processing module 35. The processing module 35 is configured to convert the data signal into displayable and further calculate the characteristics of the riding to send the displayable data to the display unit. The characteristics of the riding can include a constant speed, a speed of acceleration, a speed of stopping, a riding in reverse, and so on. The second sending module 37 is configured to send the displayable data to the display module 50, so that all the displayable data can be shown by the displaying module 50. In addition, the data processing unit 30 further comprises a storing module 39 that is configured to store all the aforementioned data, for the information of a rider.

The display module 50 can be a display screen of a computer or a telephone.

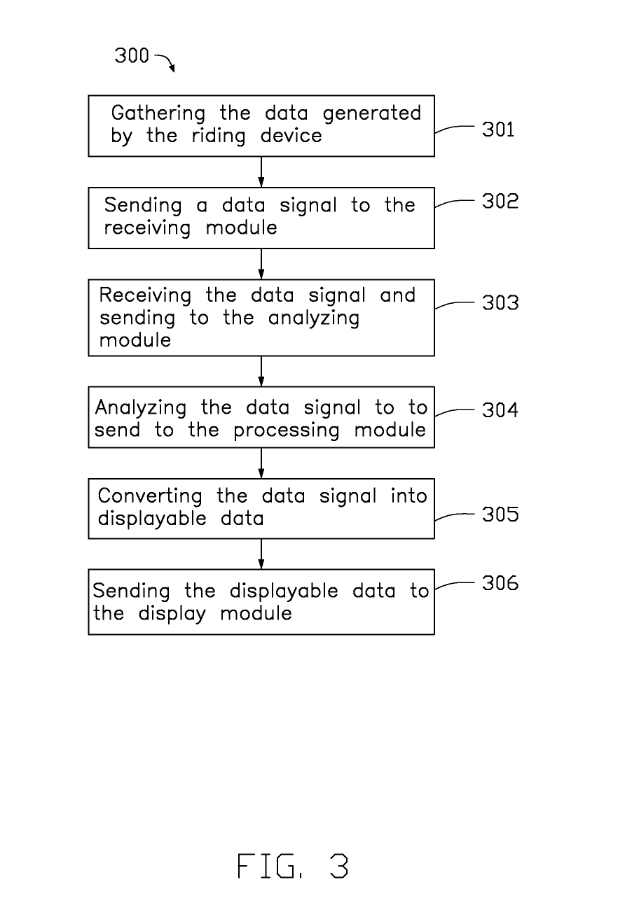

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods, or subroutines, carried out in the exemplary method 300. Furthermore, the illustrated order of blocks is by example only and the order of the blocks can change. Additional blocks may be added or fewer blocks may be utilized, without departing from this disclosure. The exemplary method 300 can begin at block 301.

At block 301, gathering data from the riding of the riding device by the gathering component 11. The gathered data can include a constant speed, a speed of acceleration, a speed of stopping, a riding in reverse, and so on.

At block 302, data signals generated by the riding device are sent to the receiving module 31 of the data processing unit 30 by the first sending module 13.

At block 303, the receiving module 31 receives the data signals from the riding device and passes the data signals on to the analyzing module 33 of the data processing unit 30.

At block 304, the analyzing module 33 analyzes the data signals and sends the same to the processing module 35.

At block 305, the processing module 35 performs calculations on the data signals, as to a constant speed, a speed of acceleration, a speed of stopping, a riding in reverse, and so on, and further convert the data signal into displayable data.

At block 306, the second sending module 37 sends the displayable data to the display module 50 for display.

The embodiments shown and described above are only examples. Many details are often found in the art such as the other features of an information gathering device and an information gathering method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An information gathering device comprising:
a gathering unit configured to be located on a riding device to gather data generated by the riding device;
a data processing unit coupled to the gathering unit; and
a display unit coupled to the data processing unit;
wherein the gathering unit is configured to send a data signal to the data processing unit, the data processing unit is configured to convert the data signal into displayable and send the displayable data to the display unit, and the display unit is configured to display the displayable data received from the data processing unit.

2. The information gathering device of claim 1, wherein the data generated by the riding device comprises a constant speed, a speed of acceleration, a speed of stopping, and a riding in reverse.

3. The information gathering device of claim 2, wherein the gathering unit comprises a gathering component, and the data is gathered by the gathering component.

4. The information gathering device of claim 3, wherein the gathering component is a G-sensor, an accelerometer, or a gyroscope.

5. The information gathering device of claim 3, wherein the gathering unit further comprises a first sending module coupled to the gathering component, the data processing unit further comprises a receiving module coupled to the first sending module, and the first sending module is configured to send the data signal to the receiving module.

6. The information gathering device of claim 1, wherein the data processing unit further comprises an analyzing module and a processing module coupled to the analyzing module, the analyzing module is configured to analyze the signal of the data to obtain the data of the riding device to send to the processing module, and the processing module is configured to calculate the data of the riding device to send to the display module.

7. The information gathering device of claim 6, wherein the data processing unit further comprises a second sending module coupled to the processing module, and the second sending module is configured to send the data of the riding device to the display module.

8. The information gathering device of claim 1, wherein the display module is a monitor of a computer or a telephone.

9. The information gathering device of claim 1, wherein the riding device is a bicycle.

10. An information gathering method comprising:
gathering data generated by a riding device by a gathering unit located on the ride device;
sending a data signal to a data processing unit by a first sending module of the gathering unit;
converting the data signal into displayable and send the displayable data to the display unit; and
displaying the displayable data by a display unit coupled to the data processing unit.

11. The information gathering method of claim 10, wherein the data generated by the riding device comprises a constant speed, a speed of acceleration, a speed of stopping, and a reverse riding.

12. The information gathering method of claim 10, wherein the gathering unit comprises a gathering component, and the data is gathered by the gathering component.

13. The information gathering method of claim 12, wherein the gathering component is a G-sensor, an accelerometer, or a gyroscope.

14. The information gathering method of claim 12, further comprising: sending the data signal to a receiving module of the data processing unit by a first sending module.

15. The information gathering method of claim 10, wherein the display module is a monitor of a computer or a telephone.
